(19) United States
(12) Patent Application Publication
(10) Pub. No.: US 2024/0100451 A1
(43) Pub. Date: Mar. 28, 2024

(54) CERAMIC FRIT WITH HOLDING UNIT AND FILTER UNIT MADE OF ONE PIECE

(71) Applicant: Agilent Technologies, Inc., Santa Clara, CA (US)

(72) Inventor: Rene Hoelzer, Waldbronn (DE)

(21) Appl. No.: 18/275,393

(22) PCT Filed: Feb. 7, 2022
(86) PCT No.: PCT/IB2022/051042

§ 371 Date: Aug. 1, 2023

(30) Foreign Application Priority Data
Feb. 8, 2021 (DE) 10 2021 102 851.5

(51) Int. Cl. B01D 15/22; G01N 30/60

(52) U.S. Cl. CPC B01D 15/22; G01N 30/603

(57) ABSTRACT

A frit for a sample separation device for separating a fluidic sample includes a holding unit made of ceramic and a filter unit made of ceramic, which is held by the holding unit for filtering a fluid. The holding unit and the filter unit are formed as one piece.

### CROSS-REFERENCE TO RELATED APPLICATIONS

This application is the national stage under 35 U.S.C. 371 of International Application No. PCT/IB2022/051042, filed on Feb. 7, 2022; which claims priority to German Application No. DE 10 2021 102 851.5, filed on Feb. 8, 2021; the entire contents of each of which are incorporated by reference herein.

### TECHNICAL FIELD

The present invention relates to a frit, a filter component, a sample separation device, and a method for manufacturing a frit for a sample separation device for separating a fluidic sample.

### BACKGROUND

In a high-performance liquid chromatography (HPLC) system, typically a liquid (mobile phase) is moved with a very precisely controlled flow rate (for example in a range of microliters up to milliliters per minute) and at a high pressure (typically 20 to 1000 bar and above, currently up to 2000 bar), where the compressibility of the liquid may be noticeable, through a so-called stationary phase (for example in a chromatographic column), to separate single components of a sample liquid which is introduced in the mobile phase from each other. For example, such a HPLC-system is known from EP 0,309,596 B1 of the same applicant, Agilent Technologies, Inc.

At a hose end by which a liquid is sucked out of a storage container, for example for the chromatography, porous bodies are attached and are denoted as inlet fits. Frequently, they have the shape of a cylinder with a connection piece for the hose which is attached on the top. Also at the inlet of a chromatographic separation column, frits are arranged for filtering a fluid and for preventing the stationary phase (for example silica-particles) to be rinsed out of the chromatographic separation column. Frits may also be used for filtering the fluid which is brought to a pressure and conveyed by a fluid drive. Such frits are frequently made of a metal.

### SUMMARY

It is an object of the present disclosure to provide a frit which is robust and simple to manufacture for a sample separation device.

According to an exemplary embodiment of the present present disclosure, a frit (which may also be denoted as filter element) for a sample separation device for separating a fluidic sample is provided, wherein the frit comprises a holding unit made of ceramic and a filter unit made of ceramic which is held by the holding unit for filtering a fluid, wherein the holding unit and the filter unit are made of one piece (in particular the holding unit and the filter unit may be directly connected with each other and/or may directly adjoin each other).

According to another exemplary embodiment of the present disclosure, a filter component for connecting to a fluid conduit for filtering a fluid in a sample separation device is provided, wherein the filter component comprises a frit with the above-described features and a fitting for receiving the frit for fluidically connecting the frit to the fluid conduit (in particular between two fluid conduits).

According to a further exemplary embodiment of the present disclosure, a sample separation device for separating a fluidic sample which is in a mobile phase into fractions is provided, wherein the sample separation device comprises a fluid drive for conveying the mobile phase and/or the fluidic sample, a sample separation unit downstream of the fluid drive for separating the sample in the mobile phase, and at least one frit with the above described features for filtering at least a part of the mobile phase and/or the fluidic sample and/or for hindering a stationary phase of the sample separation unit to leave the sample separation unit.

According to yet another exemplary embodiment, a method for manufacturing a frit for a sample separation device for separating a fluidic sample is provided, wherein the method comprises producing a holding unit made of ceramic, producing a filter unit made of ceramic which is held by the holding unit for filtering a fluid, and forming the holding unit and the filter unit as one piece.

In the context of the present application, the term “frit” may in particular denote a filter component for a fluid (in particular a liquid and/or a gas, optionally comprising solid particles) which, when fluid streams through it or flows through it, completely or partially frees the fluid from solid particles. In this way, foreign matters or contaminations may be filtered out of a solvent.

In the context of the present application, the term “ceramic” may in particular denote a technical ceramic. Such technical ceramics may comprise the properties according to DIN V ENV 12212 (in the latest version at the priority day of the present application). In particular, the ceramic may be a material which may be non-metallic and inorganic. In particular, the materials of the technical ceramic include silicate ceramic, oxide ceramic and non-oxide ceramic. According to an embodiment, the ceramic may comprise or consist of aluminum oxide, aluminum nitride, titanium nitride and/or zirconium oxide, for example. Aluminum oxide has the special advantage of a high heat capacity. The use of zirconium oxide is especially advantageous when a mechanically highly robust and less brittle material is required. Also combinations of the mentioned and/or other ceramics are possible, for example to combine different material properties. For such reasons, also a ceramic powder with different particle sizes may be used as a starting material. For example, as a ceramic material for forming a frit according to an exemplary embodiment of the present disclosure, aluminum oxide may be used (for example highly pure aluminum oxide Al₂O₃, for example 96% or more).

In the context of the present application, the term “filter component” may in particular denote a fluid component which is configured for inserting in a fluidic path. For example, the component may be configured for fluidically connecting to a capillary or to another fluid conduit or between two capillaries or other fluid conduits.

In the context of the present application, the term “fitting” may in particular denote a connection body or a set of connection bodies which may be connected as a fluid-tight fluid interface between a frit and a fluid conduit (for example a capillary). For example, a fitting may be made of two or more parts which are connectable with each other (in particular screwable with each other), to which a respective fluid conduit is fluid-tightly connectable and between which a frit may be received and may be coupled in the fluidic path between the fluid conduits.

In the context of the present application, the term “holding unit and filter unit made of ceramic which are formed as one piece” may in particular denote a ceramic body which cannot be separated without a destruction of the frit in the holding unit and in the filter unit for filtering solid particles out of a fluid. In particular, the holding unit and the filter unit which are made of one piece may be made of one substance, i.e. may be made of the same ceramic material or may be monolithic. However, a ceramic body of the holding unit and the filter unit which is made of one piece may differ in its material properties in the region of the holding unit and in the region of the filter unit, to ensure the holding function of the holding unit and the filter function of the filter unit. For example, the holding unit may be made of a fluid-impermeable ceramic (which is for example fluid-tight and is substantially free from inner hollows), and the filter unit may be made of a fluid-impermeable (for example porous) ceramic. The holding unit and the filter unit may be formed as an inhomogeneous ceramic body.

In the context of the present application, the term “sample separation device” may in particular denote a device which is capable and configured to separate a fluidic sample, for example to separate into different fractions. For example, the sample separation may be performed by a chromatography or an electrophoresis. For example, the sample separation device may be a liquid chromatography sample separation device (for example a HPLC) or a gas chromatography sample separation device.

In the context of the present application, the term “fluidic sample” in particular denotes a medium which contains the material which is actually to be analyzed (for example a biological sample, such as a protein solution, a pharmaceutical sample, etc.).

In the context of the present application, the term “mobile phase” in particular denotes a fluid (further in particular a liquid) which serves as a carrier medium for transporting the fluidic sample from the fluid drive to the sample separation unit. For example, the mobile phase may be a (for example organic or inorganic) solvent or a solvent composition (for example water and ethanol).

According to an exemplary embodiment, a frit may be provided as a filter element for filtering solid particles out of a fluid in a sample separation device, which frit comprises a ceramic body made of one piece. Here, the frit may comprise a holding unit which is ceramic and impermeable for a fluid for holding the frit at a location of use, and a ceramic filter unit which is held by it and is permeable for the fluid for filtering the fluid. Here, advantageously, the holding unit and the filter unit may be formed as a common, inhomogeneous (for example partially porous and partially pore-free) ceramic body, so that the number of the parts which are to be handled by a user may be kept low. Such a frit may be advantageously fitted in a fluid component which may be fluid-tightly connected to a fluid conduit or between two fluid conduits. In this way, a frit according to an embodiment of the present disclosure may be mounted in a simple manner and thus error-robustly at arbitrary positions in a sample separation device or at another location of use. Thus, according to an exemplary embodiment, with a low manufacturing effort and handling effort, but in a reliable manner, a bioinert frit for fluid filtering in a sample separation device or for another application may be provided. A ceramic and thus bioinert frit according to an exemplary embodiment of the present disclosure substantially interacts neither with (for example chemically aggressive organic) solvents nor with biological, chemical, or pharmaceutical samples. Therefore, such a bioinert frit influences neither the mobile phase nor the fluidic sample during a sample separation. Furthermore, such a frit is protected against a chemical attack (for example by corrosion) by the mobile phase or the fluidic sample. Furthermore, by such a frit, it may be reliably avoided that foreign matters (for example small solid particles caused by abrasion in a pump or the like) enter in a fluidic path and influence the accuracy of a sample separation there, for example. By enabling a user to handle such a frit as one piece, an erroneous operation is almost excluded, and also a user without special knowledge may achieve a fluid filtering. Moreover, a ceramic frit made of one piece with a functional portion for fluid filtering and another functional portion for holding may be manufactured with a low effort. In addition, a ceramic frit according to an embodiment of the present disclosure shows a high degree of mechanical robustness and may therefore free a fluid from solid particles in a reliable manner and over a large period of time, without the need to be frequently exchanged. Advantageously, a frit made of one piece made of ceramic may also withstand high and highest pressures of 1000 bar and more, as they may occur in a HPLC, for example.

In the following, additional embodiments of the frit, the fluid component, the sample separation device, and the method are described.

According to an embodiment, the entire frit may consist of ceramic. When the entire frit consists exclusively of the ceramic, a special robustness of the frit during the operation may be provided by the ceramic material. At the same time, such a ceramic may show a good heat conductivity. Ceramic material is also bioinert, so that, even in the presence of an aggressive chemical solvent or a biochemical sample, it is neither damaged nor has an undesired effect on the sample. Moreover, ceramics may be processed in powder form, wherein this powder may be provided with a binder during the manufacture of the frit which may be solidified by an energy source for manufacturing the frit.

According to another embodiment, besides the ceramic, the frit may comprise one or more other materials, for example residues of the solidified binder which were not or not completely removed from the body during sintering or burning.

According to an embodiment, the frit may comprise a chemical filter coating at least at the filter unit. The mechanical filter function of the filter unit due to its porosity may be further improved, when the filter unit is at least in portions covered with a chemical filter coating which further enhances the filter effect. For example, the chemical filter coating may increase the adhesion of solid particles at the filter unit and may thus, additionally to the mechanical filter function, synergistically provide a chemical filter function. For example, a chemical filter coating may be configured to filter certain components or particles out of a fluid which are (in particular specifically) adsorbed at the chemical filter coating. It is also possible to attach such a chemical filter coating at least at a partial region of the frit, so that the frit is specifically equipped with a hydrophobic or with a hydrophilic property, to thereby influence the filter properties.

According to an embodiment, the frit may comprise a sealing elevation which is annularly surrounding the filter unit, i.e. an elevated annular sealing edge. The latter may in particular be a sealing coating (in particular made of a non-ceramic material) or a ceramic sealing elevation which is formed as one piece with the holding unit and the filter unit. Such a sealing coating may consist of the same material as the ceramic holding body and filter body which is made of one piece and may thus be a ceramic sealing ring. In other embodiments, the sealing coating may also consist of another material than the ceramic holding body and filter body, in particular may also be made of a bioinert material, such as gold, or made of a bioinert plastic, such as PEEK (polyetheretherketone) or PTFE (polytetrafluoroethylene).

According to an embodiment, the holding unit may be a holding ring. This holding ring may fully circumferentially surround a plate-shaped or disk-shaped filter unit.

According to an embodiment, the filter unit may be a filter disk which is circumferentially held by the holding ring. In other words, a plate-shaped or disk-shaped filter unit may form a central region and the holding unit may form a circumferential outer region of the frit. The entire frit may be a disk with a circular circumference.

According to an embodiment, the filter unit may be a porous body or portion, in particular with pore sizes in a range from 3 μm to 10 μm. Pores in the mentioned size range have turned out as especially advantageous to effectively filter solid particles which arise in a sample separation device (for example a liquid chromatography device), which may originate from an abrasion at a fluid drive, for example, without thereby excessively increasing the fluidic resistance of the frit.

According to an embodiment, the filter unit may be a porous body, in particular with a porous media grade (pmg) in a range from 0.3 to 1 (in particular according to DIN ISO 4003: 1990-10). For example, in a porous medium of the grade 0.3, a boundary-passage size of particles in a fluid to be filtered may be 3 μm.

According to an embodiment, the holding unit may be a solid body. The holding unit may be free from pores and macroscopic hollows. Thereby, the mechanical robustness of the holding unit is increased. At the same time, the fluid stream through the frit may thereby be specifically guided through the filter unit, which may be arranged in a central portion of the frit. Thereby, the functions of filtering and holding may be spatially separated in the frit and may thereby be specifically adjusted.

According to an embodiment, the holding unit and the filter unit may be made of the same ceramic material. This ensures an especially good inner connection between the holding unit and the filter unit. Material bridges in the interior of the frit are thereby avoided. Moreover, the ceramic formation of the filter unit and the holding unit which are made of one substance causes a further simplification of the manufacturing process of the frit.

According to an embodiment, the frit may be metal-free. Thereby, the frit may be reliably protected against corrosion and an undesired interaction between the fluid (in particular an aggressive solvent of the mobile phase and/or an aggressive fluidic sample) and material of the frit.

According to an embodiment, the frit may be bioinert. In other words, the frit may be made of a material or materials which does or do not show an undesired interaction with biological or chemical materials which may be contained in a fluidic sample and/or a mobile phase which flows through the frit. In particular, ceramics and plastics may be bioinert, as well as certain metals (for example gold).

According to an embodiment, the frit may be high-pressure-tight, in particular at least up to 1000 bar. Such pressures may occur in sample separation devices, for example a liquid chromatography sample separation device or a HPLC in operation, in particular provided by a fluid which is configured as a high-pressure pump. By a formation of the frit which is made of one piece and ceramic, a sufficient pressure-tightness may be ensured.

According to an embodiment, the frit may comprise a thickness in a range from 0.1 mm to 10 mm, in particular in a range from 0.3 mm to 1 mm. Such a frit enables a compact configuration without an excessive dead volume and without excessively increasing the fluidic resistance in the fluidic path to be filtered. At the same time, the mentioned thickness range enables reliably filtering foreign matters as it occurs in particular in sample separation devices.

According to an embodiment, the frit may comprise an outer diameter in a range from 1 mm to 20 mm, in particular in a range from 3 mm to 10 mm. A frit with such dimensions perpendicular to a fluid flow enables a compact fluid filtering and at the same time a good handleability by a user.

According to an embodiment, the filter unit may comprise an outer diameter in a range from 0.5 mm to 10 mm, in particular in a range from 1 mm to 4 mm. With such dimensions of the filter unit perpendicular to a fluid flow, the fluidic resistance through the frit may be kept sufficiently low. Moreover, an excessive radial enlargement of the fluid flow may thereby be avoided.

Furthermore, with such dimensions, a distinct filter function in a sample separation device may be achieved.

Advantageously, the outer diameter of the filter unit may be larger than an inner diameter of a fluid conduit (in particular a capillary) which is connected to the frit. The fluidic resistance of a porous filter unit which is higher with respect to the lumen of a fluid conduit may just be compensated by an outer diameter of the filter unit which is correspondingly increased with respect to the inner diameter of the fluid conduit, to adapt the flow rate through the fluid conduit to the flow rate through the filter unit. In this way, fluidic artifacts in a transition between a fluid conduit and the filter unit may be avoided.

According to an embodiment, the frit may comprise a sealing structure for fluid-tightly connecting the frit, in particular to a fitting. Such a sealing structure may annularly surround the filter unit, so that during filtering no fluid can escape in a radial direction from the filter unit to the holding unit. A leakage may be advantageously avoided with such a sealing structure.

According to an embodiment, the sealing structure may comprise a ceramic sealing ring which is arranged at the holding unit as one piece. Then, the holding unit, the filter unit, and the sealing structure may be formed as a common body formed as one piece, in particular made of one substance (i.e. made of the same ceramic material). This avoids material bridges and delamination and promotes a simple manufacturability. According to an embodiment, the filter component may comprise a material pairing, wherein a material of the frit which is in contact with the fitting at a sealing position is ceramic, and wherein a material of the fitting which is in contact with the frit at the sealing position is plastic (for example PEEK).

According to an embodiment, the sealing structure may comprise a sealing ring made of a bioinert metal which is attached to the holding unit, in particular made of gold. Gold is especially suitable for sealing at highest pressures, in particular up to 1300 bar or more. Therefore, a gold sealing is especially suitable for a HPLC. At the same time, gold is advantageously bioinert. According to an embodiment, the filter component may comprise a material pairing, wherein a material of the frit which is in contact with the fitting at a sealing position is gold, and wherein a material of the fitting which is in contact with the frit at the sealing position is steel.

According to yet another embodiment, the sealing structure may comprise a sealing ring which is attached to the holding unit (for example made of plastic, in particular made of a polymer, such as PEEK). Advantageously, the elevated sealing ring may be embedded in a ring groove and/or in at least a blind hole of the holding unit. A plastic sealing is especially suitable in combination with a sealing partner (in particular a fitting-part) made of steel. A sealing structure made of plastic may be embedded in an annular groove of a ceramic body which forms the holding unit and the filter unit in an especially error-robust manner.

According to an embodiment, the fitting may comprise screwable parts for fluid-tightly receiving the frit. In particular, a male screwing part may be screwed in a female screwing part of the fitting, and the frit may be arranged between the male screwing part and the female screwing part in the interior of the fitting. Each of the parts (in particular screwing parts) may be fluid-tightly connected to a fluid conduit (for example a capillary). By mounting (in particular tightly screwing) both screwing parts with the frit arranged in between, a fluid-tight (in particular high-pressure-tight, for example tight up to at least 1200 bar) connection between the fluid conduits, the frit, and the fitting may be formed.

According to an embodiment, at least one of the at least one frit may be arranged downstream of the fluid drive, in particular between the fluid drive and the sample separation unit. A frit which is arranged at this position in the fluidic path may in particular filter the abrasion between a piston and a piston chamber of the fluid drive out of the fluid, before it reaches the sample separation unit.

According to an embodiment, at least one of the at least one frit may be arranged between an injector unit (or sample introduction unit) for inserting the fluidic sample in the mobile phase and the sample separation unit. In this way, an undesired ingression of foreign matters or particles in the sample separation unit (for example a chromatographic separation column) may be avoided which may be caused by the injection process (connected with switching a fluid valve) and/or by foreign matters in the fluidic sample, for example.

According to an embodiment, at least one of the at least one frit may be arranged upstream of the fluid drive, in particular at a solvent container for providing a solvent for the mobile phase and/or between a solvent container for providing a solvent for the mobile phase and the fluid drive. For forming a mobile phase—for example in a gradient mode of a sample separation device—different solvents (for example water and an organic solvent, such as methanol) from solvent containers may be mixed in a certain ratio. Solid particles in a solvent of a solvent container may be undesired in the mobile phase. By at least one frit according to an exemplary embodiment of the present disclosure filtering the solvents which originate from the solvent containers, before these reach the fluid drive, the correctness of a solvent composition for forming the mobile phase may be improved. For example, a respective frit may be mounted at an end of the fluid conduit which is inserted in the respective solvent container for supplying the solvent to the fluid drive.

According to an embodiment, at least one of the at least one frit may be arranged at an inlet and/or at an outlet of the sample separation unit. At the inlet and/or at the outlet of a chromatographic separation column, a respective frit according to an embodiment of the present disclosure for filtering the fluid and for preventing the rinsing of the stationary phase out of the chromatographic separation column may be provided. In addition, with such a frit, an undesired ingression of foreign matters or particles in the stationary phase of a sample separation unit may be avoided.

According to an embodiment, the method may comprise simultaneously forming and connecting the holding unit and the filter unit (in particular by sintering). In particular, sintering may be caused under applying a sinter force on ceramic particles and/or under heating to a sinter temperature. For example, a ceramic powder (for example provided with additives) may be pressed in a heated press to a frit according to an exemplary embodiment of the present disclosure. The additives in the region of the holding unit may be completely or partially other ones than in the region of the filter unit.

According to an embodiment, the method may comprise producing the filter unit by sintering a mixture of sinterable particles and of volatile particles or medium, so that, after sintering, the sinterable particles form the filter unit and the volatile particles and/or the volatile medium evaporates during sintering, leaving pores behind. Moreover, the method may comprise producing the holding unit by sintering a mixture of sinterable particles. For example, additionally to the ceramic particles both in the region of the holding unit and in the region of the filter unit, a binder may be provided which contributes to binding the ceramic particles during sintering. Moreover, a volatile sacrificial material (for example a solvent which evaporates at high temperatures and/or a plastic material which evaporates at high temperatures) may be provided, for example only in the region of the filter unit, not in the region of the holding unit, so that, during sintering, only in the region of the filter unit, a porous ceramic remains. Descriptively, at the position of the former sacrificial material in a frit according to an exemplary embodiment of the present disclosure, pores remain.

According to an embodiment, the method may comprise producing the filter unit by particle size selecting of the particles. Thereby, the pore size and thus the fluidic permeability properties of the filter unit may be specifically adjusted.

According to an embodiment, the method may comprise producing the filter unit by mixing particles. By mixing different particles, for example particles with different sizes and/or materials, the filter properties of the frit may be specifically influenced.

According to an embodiment, the method may comprise producing the filter unit by casting particles. Casting is an alternative for manufacturing the frit by sintering.

According to an embodiment, the method may comprise producing the filter unit by drying particles. By the suppression of excessive liquid amounts in a raw material for manufacturing a frit according to an exemplary embodiment of the present disclosure, an undesired influence on the filter properties and a possibly undesired permeability in the region of the holding unit may be avoided by forming hollows by evaporation of water during sintering.

According to an embodiment, the method may comprise producing the filter unit by grinding and/or polishing interconnected particles. In other words, a manufactured frit may be post-processed to precisely adjust its properties or to anneal the frit.

According to an embodiment, the sample separation unit may be configured as a chromatographic separation unit, in particular as a chromatography separation column. In a chromatographic separation, the chromatography separation column may be provided with a stationary phase and/or an adsorption medium. At this, the fluidic sample may be retained and only subsequently released again in fractions more slowly or in the presence of a specific solvent composition, whereby the separation of the sample into its fractions is accomplished.

The sample separation device may be a microfluidic measuring device, a life science device, a liquid chromatography device, a HPLC (high-performance liquid chromatography) device, a UHPLC (ultra-high-performance liquid chromatography) device, an SFC—(supercritical liquid chromatography) device, a gas chromatography device, an electrophoresis device, and/or a gel electrophoresis device. However, many other applications are possible.

For example, the pumping system may be configured to convey the mobile phase with some 100 bar up to 1000 bar and more, for example, through the system.

The sample separation device may comprise a sample injector for introducing the sample in the fluidic separation path. Such a sample injector may comprise an injection needle which is couplable with a seat in a corresponding liquid path, wherein the needle may be extended out of the seat to receive the sample, wherein, after retracting the needle in the seat, the sample is located in a fluid path which, for example by switching a valve, may be connected to the separation path of the system which leads to an introduction of the sample in the fluidic separation path.

The sample separation device may comprise a fraction collector for collecting the separated components. Such a fraction collector may lead the different components into different liquid containers, for example. However, the analyzed sample may also be supplied to a drain container.

The sample separation device may comprise a detector for a detection of the separated components. Such a detector may generate a signal which may be observed and/or recorded, and which is indicative for the presence and the amount of the sample components in the fluid which flows through the system.

### BRIEF DESCRIPTION OF THE DRAWINGS

Other objects and many of the accompanying advantages of embodiments of the present disclosure will be easy to recognize and better to understand with reference to the following detailed description of embodiments in connection with the accompanying drawings. Features which are substantially or functionally same or similar, are denoted with the same reference signs.

FIG. 1 shows a HPLC-system according to an exemplary embodiment of the present disclosure.

FIG. 2 shows a spatial cross-sectional view of a frit according to an exemplary embodiment of the present disclosure.

FIG. 3 shows another cross-sectional view of the frit according to FIG. 2.

FIG. 4 shows a three-dimensional view of the frit according to FIG. 2.

FIG. 5 shows single parts of a filter component according to an exemplary embodiment of the present disclosure.

FIG. 6 shows an assembled filter component according to an exemplary embodiment of the present disclosure.

FIG. 7 shows a frit with a sealing structure according to exemplary embodiments of the present disclosure.

FIG. 8 shows a frit with a different sealing structure according to an exemplary embodiment of the present disclosure.

FIG. 9 shows a frit with a different sealing structure according to an exemplary embodiment of the present disclosure.

FIG. 10 shows a frit with a different sealing structure according to an exemplary embodiment of the present disclosure.

FIG. 11 shows a method for manufacturing a frit according to an exemplary embodiment of the present disclosure.

The illustrations in the are schematic.

### DETAILED DESCRIPTION

Before, referring to the drawing figures, exemplary embodiments of the present disclosure are described in more detail, some general considerations of the present disclosure shall be described, on whose basis exemplary embodiments of the present disclosure have been developed.

Conventional filter elements comprise stainless steel, titanium, or polymers and/or combinations thereof (for example a PEEK-ring and a porous body made of stainless steel), for example. Conventional filter elements are frequently not metal-free due to the mentioned materials, and/or do not withstand high pressures due to their material properties.

To overcome at least a part of the mentioned and/or other disadvantages in prior art, according to an exemplary embodiment of the present disclosure, a porous filter frit made of ceramic which is made of one piece is provided. According to an embodiment of the present disclosure, the entire filter element (namely a filter body and a holding body or handling body) consists of one piece of ceramic, and in an embodiment with different material properties in portions. A radially central filter unit and/or a filter body may be permeable for a fluid and may prevent solid particles in the fluid to pass the frit and retain these. In contrast, a radially outer holding unit, in particular a holding ring, may be made of solid ceramic which is impermeable for a fluid, and may serve for the stability and handling of the frit.

Thus, an exemplary embodiment of the present disclosure provides a ceramic filter frit which is made of one piece, which may be in particular advantageously used in sample separation devices. In this context, made of one piece in particular means, that a massive ceramic ring as the holding unit and a porous ceramic frit material in a ring opening of the holding unit as the filter unit are tightly connected with each other or not separable from each other. Already during an additive manufacturing method of the frit, the ceramic holding unit and the ceramic filter unit may be manufactured as a common body with inhomogeneous ceramic properties (in particular with different degrees of porosity). This increases the stability and the resistance to wear and promotes a pressure-tightness of, for example, at least 1000 bar or more. Due to the used ceramic materials, a bioinert and completely metal-free frit may be provided.

Advantageously, a bypass of the frit by particles in a fluid to be filtered may be avoided by a design of the frit with a sinter-bonded ceramic ring and a porous ceramic frit filter as material which is filtering and surrounded by the ceramic ring. Advantageously, such a frit withstands even a high pressure due to the good compression strength of ceramic, as it may occur in sample separation devices, for example a HPLC.

A method for manufacturing a frit according to an exemplary embodiment of the present disclosure may be performed with a low effort. For example, such a manufacturing method may encompass a preparation of a ceramic powder (in particular under selecting a grain size and a mixture), a reshaping or casting a green compact, and optionally drying, a sintering for forming an inherently coherent ceramic body, and optionally a finishing of the obtained frit (for example by grinding, polishing).

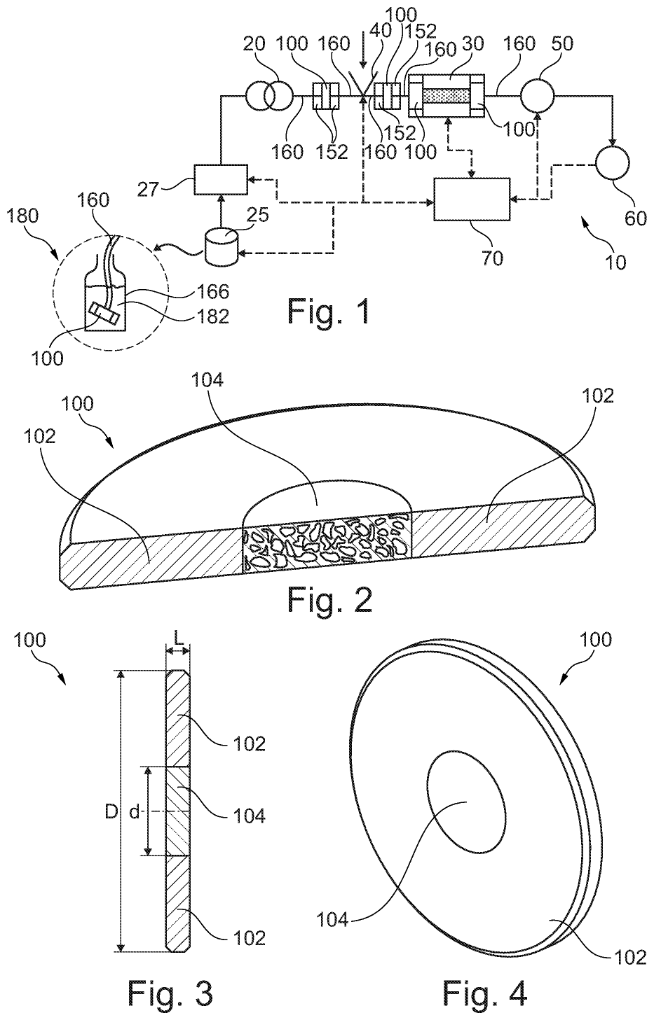

FIG. 1 shows the basic structure of a HPLC-system 10 as it may be used for a liquid chromatography, for example. A fluid drive 20 which is supplied with solvents from a supply unit 25, drives a mobile phase through a sample separation unit 30 (such as a chromatographic column) which includes a stationary phase. A degasser 27 may degas the solvents before these are supplied to the fluid drive 20. A sample introduction unit 40 (also denoted as injector) is arranged between the fluid drive 20 and the sample separation unit 30, to introduce a sample liquid in the fluidic separation path. The stationary phase of the sample separation unit 30 is provided for separating the components of the fluidic sample. A detector 50, for example a flow cell, detects the separated components of the sample, and a fractionator 60 may be provided for outputting the separated components of the sample in containers which are provided for this purpose. After passing the detector 50, the liquids may be output in a drain container or the fractionator 60.

While a liquid path between the fluid drive 20 and the sample separation unit 30 is typically under high pressure, the sample liquid is at first introduced under normal pressure in a region which is separated from the liquid path, a so-called sample loop of the sample introduction unit 40, which then in turn introduces the sample liquid in the liquid path which is under high pressure. While connecting the sample liquid in the sample loop which is at first under normal pressure into the liquid path which is under high pressure, the content of the sample loop is brought to the system pressure of the sample separation device 10 which is configured as a HPLC. A control unit 70 controls the single components 20, 25, 27, 30, 40, 50, 60 of the sample separation device 10.

During the operation of the sample separation device 10, a mobile phase as solvent composition is guided through the fluid conduits 160 (for example capillaries) which fluidically connect the single components 20, 25, 27, 30, 40, 50, 60 with each other. In a corresponding manner, the fluidic sample which is introduced by the sample introduction unit 40 in a fluidic path between the fluid drive 20 and the sample separation unit 30, is guided through the fluid conduits 160 of the sample separation device 10. Here, it may happen, that the mobile phase and/or the fluidic sample is or are loaded with contaminations, for example small solid particles. For example, in reciprocating of a piston in the fluid drive 20, abrasion may be generated which manifests in form of small particles in the mobile phase. Furthermore, in case of a solvent container 166 which is open at the top (see detail 180 of the supply unit 25), dirt from the environment may enter the solvent 182 and from there in the mobile phase. Furthermore, a liquid sample to be examined which is supplied to the sample introduction unit 40 may be contaminated with small solid particles. Under unfavorable circumstances, such solid particle contaminations in the mobile phase and/or the fluidic sample may falsify a separation result or may shorten the life duration of the components of the sample separation device 10 and/or may lead to a clogging.

To filter parasitic solid particles out of the mobile phase and/or the fluidic sample, at the sample separation device 10, a frit 100 may be introduced in the fluidic path at one or more positions and may be fluidically coupled with the fluid conduits 160 and/or the single components 20, 25, 27, 30, 40, 50, 60 of the sample separation device 10. According to an exemplary embodiment of the present disclosure (see for example FIG. 2), the frit 100 may comprise a ceramic body which is made of one piece, which fulfills both a holding function and a filter function. In particular, such a frit 100 may function for filtering the mobile phase and/or the fluidic sample and/or for hindering a stationary phase of the sample separation unit 30 to leave the sample separation unit 30. The frit 100 may be fluidically connected with a fitting 152 with a respective fluid conduit 160, which is schematically illustrated in FIG. 1.

As illustrated in FIG. 1, such a frit 100 may be arranged upstream of the fluid drive 20, in the illustrated embodiment at a solvent container 166 for providing a solvent for the mobile phase. In more detail, the frit 100 may be connected to the end of a fluid conduit 160 which, commonly with the frit 100, immerses in the solvent 182 in the solvent container 166. In this way, already pre-filtered solvents are supplied to the fluid drive 20. Alternatively or additionally, a frit 100 may be provided between the solvent container 166 of the supply unit 25 for providing a solvent for the mobile phase and the fluid drive 20 (not shown).

It is further shown in FIG. 1, that a frit 100 according to an exemplary embodiment of the present disclosure may be arranged downstream of the fluid drive 20, namely between the fluid drive 20 and the sample separation unit 30, for example. Thereby, for example a piston abrasion of the fluid drive 20 may be filtered before reaching the sample separation unit 30.

It may also be recognized in FIG. 1, that a frit 100 according to an exemplary embodiment of the present disclosure may be arranged between the injector unit or sample introduction unit 40 for introducing the fluidic sample in the mobile phase and the sample separation unit 30. For example, a solid particle contamination which originates from the sample introduction unit 40 and/or the fluidic sample may be removed at this frit 100 by filtering.

Moreover, a respective frit 100 according to an exemplary embodiment of the present disclosure may be arranged at an inlet and/or an outlet of the sample separation unit 30. Thereby, not only a further purifying and/or filtering of the fluidic sample and/or the mobile phase prior to the sample separation is performed. Instead, the frit 100, in particular at the outlet of the sample separation unit 30, additionally serves for the stationary sample remaining in the interior of the sample separation unit 30 and not being rinsed out of it.

A skilled person will recognize that, according to other embodiments of the present disclosure, alternatively or additionally, a frit 100 may also be arranged at another fluidic position of the sample separation device 10. Moreover, it is possible to use a frit 100 according to an exemplary embodiment of the present disclosure for other applications than in an analytical sample separation device, for example for preparation applications.

In the following, referring to FIG. 2 to FIG. 10, examples for frits 100 or a filter component 150 with such a frit 100 according to exemplary embodiments of the present disclosure are described. Such embodiments may be used in the sample separation device 10 according to FIG. 1, for example.

FIG. 2 shows a spatial cross-sectional view of a frit 100 according to an exemplary embodiment of the present disclosure. FIG. 3 shows a cross-sectional manufacturing view of the frit 100 according to FIG. 2. FIG. 4 shows a three-dimensional view of the frit 100 according to FIG. 2 and FIG. 3.

The frit 100 which is illustrated in FIG. 2 to FIG. 4 is for example suitable for a use in a sample separation device 10 for separating a liquid sample using a liquid mobile phase. As illustrated, the frit 100 comprises a holding unit 102 made of a solid ceramic and a filter unit 104 made of a porous ceramic which is held by the holding unit 102. Advantageously, the holding unit 102 and the filter unit 104 are made of one piece. According to FIG. 2 to FIG. 4, the entire frit 100 consists of the same ceramic material, for example aluminum oxide. In the described embodiment, the holding unit 102 is configured as a holding ring, and the filter unit 104 is configured as a filter disk which is circumferentially surrounded and held by the holding ring. Here, the filter unit 104 is a porous ceramic body, whereas the holding unit 102 is a ceramic solid body. The filter unit 104 has pore sizes in a range from 3 μm to 10 μm, for example. A porous media grade of the filter unit 104 is for example in a range from 0.3 to 1 (according to DIN ISO 4003: 1990-10). In this way, solid particles as they typically occur in an operation of a chromatographic sample separation device 10 may be reliably filtered out of the fluid stream by the frit 100.

Advantageously, the holding unit 102 and the filter unit 104 may be made of the same ceramic material, for example of aluminum oxide. By avoiding material bridges, an especially robust, wear-resistant and pressure-tight frit 100 may thereby be obtained. According to FIG. 2 to FIG. 4, advantageously, the purely ceramic frit 100 is additionally metal-free and therefore completely bioinert. An interaction between the material of the frit 100 and a chemically and/or biologically aggressive material of the fluidic sample and/or the mobile phase may thereby be excluded in an advantageous manner.

Especially advantageous for the application in a HPLC is that the frit 100 which is illustrated in FIG. 2 to FIG. 4 is high-pressure-tight, namely up to 1000 bar and more. In particular in a boundary region between the solid holding unit 102 and the porous filter unit 104, the material connection which is made of one substance is highly robust and leakage-tight due to the manufacture of the frit 100 by sintering.

As shown in FIG. 3, the frit 100 has a thickness L in a range of, for example, 0.3 mm to 1 mm. Advantageously, an outer diameter D of the frit 100 is in a range from 3 mm to 10 mm. Moreover, the filter unit 104 of the frit 100 has an outer diameter d in a range of, for example, 1 mm to 4 mm. This value may be advantageously combined with typical inner diameters of capillaries of 0.17 mm, so that due to the outer diameter d which is increased with respect to the inner diameter of the capillary and under consideration of the higher fluidic resistance of the porous ceramic material in the region of the filter unit 104, the fluid flow is performed substantially undisturbed in a transition between the capillary and the frit 100. Thereby, a back pressure of streaming fluid in the region of the frit 100 may be avoided.

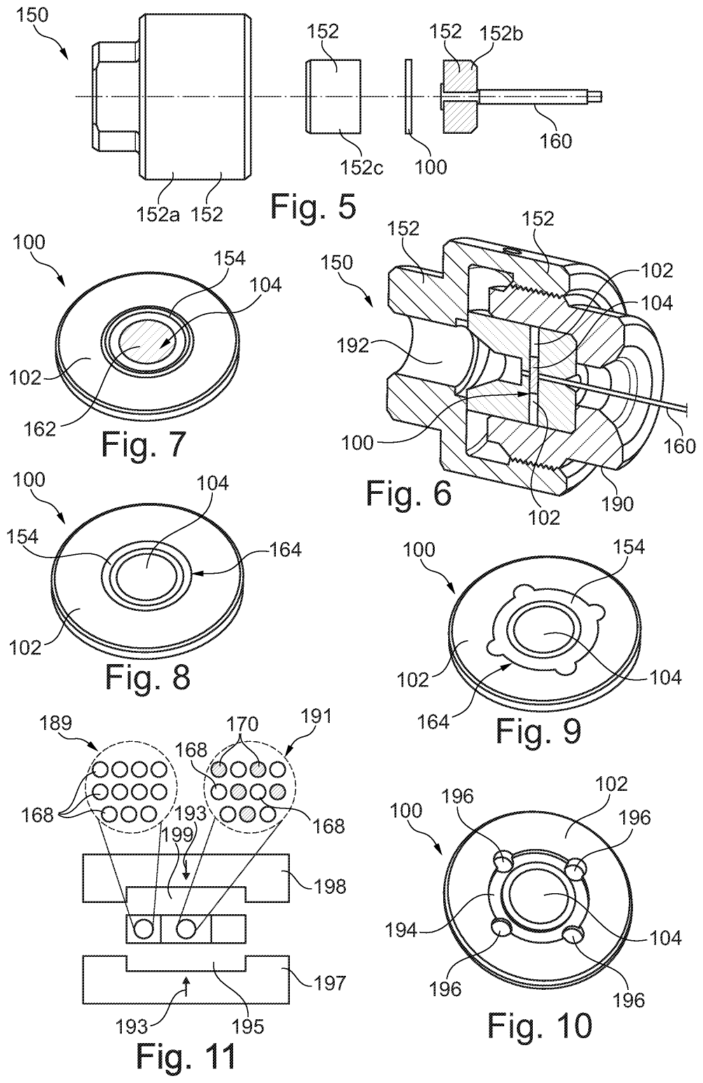

FIG. 5 shows single parts of a filter component 150 according to an exemplary embodiment of the present disclosure.

Descriptively, the illustrated filter component 150 serves for fluid-tightly mounting or connecting a frit 100 to one or two fluid conducting fluid conduits 160, for example capillaries. In this way, by the frit 100, liquid-tightly filtering a fluid in a sample separation device 10 may be accomplished. As shown in the exploded illustration according to FIG. 5, the filter component 150 comprises a frit 100 (for example with the properties according to FIG. 2 to FIG. 4) and a multi-piece fitting 152 for receiving the frit 100 for fluidically connecting the frit 100 to a fluid conduit 160 for conducting the fluid. In the illustrated embodiment, the fitting 152 comprises a female connection part 152a, a male connection part 152b with a connected fluid conduit 160 and an intermediate part 152c or insertion part which adjoins the frit 100. The illustrated components are combined and attached to each other by a screw connection, for example. In the mounted state, the frit 100 is liquid-tightly connected to the fluid conduit 160 and may therefore filter liquids which are conducted through the fluid conduits 160 in a leakage-free manner.

FIG. 6 shows an assembled filter component 150 according to an exemplary embodiment of the present disclosure.

The fitting 152 for fluid-tightly receiving the frit 100 according to FIG. 6 also comprises parts which are advantageously screwable to each other. One of these parts is formed with an external hexagon, see reference sign 190, to tighten the parts which are screwed to each other by a tool, and to thereby form a fluid-tight connection between the fitting 152 and the frit 100. A fluid conduit 160 which is configured as a capillary may be welded with a part of the fitting 152 under formation of a fluid-tight connection, for example. At a position which is indicated with the reference sign 192, a further fluid conduit 160, for example a further capillary, for forming a fluid connection may be inserted (for example using a ferrule, a cone element, or the like). While fluid is conveyed through the fluid conduit 160, the frit 100 of the fluid component 150 filters solid particles out of the conveyed fluid.

In case of a configuration of a filter component 150, especially well suitable material pairings may be combined with each other in an advantageous manner, what concerns the materials of the fitting 152 and the frit 100: in an embodiment, the material of the frit 100 at a sealing position which is in contact with the fitting 152 is a ceramic (in particular aluminum oxide), and a material of the fitting 152 at the sealing position which is in contact with the frit 100 is a plastic (e.g., PEEK). In another especially advantageous material pairing, a material of the frit 100 at a sealing position which is in contact with the fitting 152 is bioinert gold, and a material of the fitting 152 at the sealing position which is in contact with the frit 100 is steel (e.g., stainless steel).

FIG. 7 to FIG. 10 shows frits 100 with different sealing structures 154 according to exemplary embodiments of the present disclosure.

According to FIG. 7, the frit 100 comprises a ceramic sealing structure 154 for fluid-tightly connecting the frit 100 to a fitting 150 (see FIG. 5 or FIG. 6). In other words, according to FIG. 7, the sealing structure 154 comprises a ceramic sealing ring which is formed as one piece at the holding unit 102. According to FIG. 7, the sealing structure 154 is made of one piece and made of one substance with the ceramic holding unit 102 and the ceramic filter unit 104. The ceramic materials of the filter unit 104, the holding unit 102, and the sealing structure 154 may be identical, may all be aluminum oxide, for example. Also, the filter unit 104, the holding unit 102, and the sealing structure 154 according to FIG. 7 may be simultaneously formed in a common manufacturing process, for example by sintering ceramic particles. According to FIG. 7, the sealing structure 154 is formed as a ring protrusion which protrudes beyond a planar ceramic disk, wherein the ceramic disk is formed by the holding unit 102 and the filter unit 104.

According to FIG. 7, optionally, a chemical filter coating 162 may be applied at least at one surface of the filter unit 104, for example to impair hydrophilic properties to the filter unit 104, or to adjust its absorption properties. In this way, the mechanical filtering due to the porosity of the filter unit 104 may be enhanced by a chemical filter function. The provision of a surrounding ceramic sealing edge according to FIG. 7 is especially well compatible with a corresponding fitting 152 made of plastic, for example PEEK.

According to FIG. 8, the sealing structure 154 comprises a sealing ring made of a bioinert metal, such as gold, which is attached to the holding unit 102. Thus, according to FIG. 8, a sealing coating 164 made of a non-ceramic material which is annularly surrounding the filter unit 104 and which protrudes beyond the ceramic disk made of the filter unit 104 and the holding unit 102 is provided. The illustrated gold sealing may be advantageously combined with a fitting 152 made of steel, for example, and may be especially high-pressure-tight, for example up to 1300 bar.

According to FIG. 9, the annular sealing structure 154 comprises a sealing ring made of plastic at the holding unit 102, for example made of a polymer. It can be recognized in FIG. 10, that the plastic material of the sealing structure 154, which is not shown there yet, is embedded in a surrounding groove or ring groove 194 in a transition region between the holding unit 102 and the filter unit 104 and axially protrudes beyond the holding unit 102 and the filter unit 104. Partially embedding the sealing structure 154 in the annular groove or ring groove 194 suppresses a tendency of releasing the polymeric sealing structure 154 from the ceramic disk which forms the holding unit 102 and the filter unit 104. Such release tendencies may be further suppressed when the plastic material of the sealing structure 154 is additionally embedded in, for example circular, blindholes 196 which adjoin the annular groove 194.

FIG. 11 illustrates a method for manufacturing a frit 100 according to an exemplary embodiment of the present disclosure.

FIG. 11 shows a first sinter mold 197 and a second sinter mold 198 which respectively comprise a hollow 195, 199. The hollows 195, 191 define the shape of a frit 100 which is manufactured by the sinter molds 197, 198. For manufacturing a frit 100, a ceramic powder and additives are filled in the hollow between the sinter molds 197, 198. The sinter molds 197, 198 are heated to a sinter temperature, where the ceramic powder is sintered. Moreover, the sinter molds 197, 198 are charged with a pressing force, see reference sign 193. After the performed sintering, the sinter molds 197, 198 are removed and the manufactured frit 100 is removed. Therefore, in the manufacturing method for manufacturing a frit 100, connecting the holding unit 102 and the filter unit 104 may be performed by sintering, by charging a ceramic powder with a sinter force and heating the ceramic powder to a sinter temperature.

As illustrated in FIG. 11 with reference sign 191, in the method, producing the filter unit 104 by sintering a mixture of sinterable particles 168 made of a ceramic powder and of a volatile medium 170 (for example volatile particles) may be achieved, so that, after sintering, the sinterable particles 168 which are then connected to each other form the filter unit 104 and the volatile medium 170 evaporates during sintering, leaving pores. For example, the sinterable particles 168 may be ceramic particles (in particular aluminum oxide particles), which are connected to each other during sintering. On the contrary, at the adjusted sinter temperature, the volatile medium 170 evaporates, for example a solvent or a polymer which evaporates at the sinter temperature. At the positions of the meanwhile removed volatile medium 170, hollows or pores remain.

In the region of the holding unit 102 to be manufactured, only a mixture of sinterable particles 168 (i.e. without the volatile medium 170 or with a reduced concentration of the volatile medium 170 may be provided, see detail 189 in FIG. 11. Thus, the holding unit 102 is free from hollows or pores or has at least less pores after sintering than the filter unit 104.

After removing a manufactured frit 100 from the sinter molds 197, 198, in particular in the region of the filter unit 104, an optional post-process may be performed, for example by grinding and/or polishing the interconnected particles.

It should be noted that the term “comprising” does not exclude other elements, and that the term “a” does not exclude a plurality. Also elements which are described in connection with different embodiments may be combined. It should also be noted that reference signs in the claims are not to be construed as limiting the scope of protection of the claims.

1. A frit for a sample separation device for separating a fluidic sample, the frit comprising:
a holding unit made of ceramic;
a filter unit made of ceramic and held by the holding unit for filtering a fluid;
wherein the holding unit and the filter unit are formed as one piece.

2. The frit according to claim 1, comprising at least one of the following features:
wherein the entire frit comprises ceramic;
comprising a chemical filter coating at least at the filter unit;
comprising a sealing elevation annularly surrounding the filter unit;
comprising a sealing coating or a ceramic sealing elevation formed as one piece with the holding unit and the filter unit.

3. The frit according to claim 1, wherein the holding unit is a holding ring.

4. The frit according to claim 3, wherein the filter unit is a filter disk circumferentially held by the holding ring.

5. The frit according to claim 1, comprising at least one of the following features:
wherein the filter unit is a porous body;
wherein the filter unit is a porous body with pore sizes in a range from 3 μm to 10 μm;
wherein the filter unit is a porous body with a porous media grade in a range from 0.3 to 1;
wherein the holding unit is a pore-free solid body.

6. The frit according to claim 1, comprising at least one of the following features:
wherein the holding unit and the filter unit are made of the same ceramic material;
wherein the holding unit and the filter unit are made of aluminum oxide.

7. The frit according to claim 1, wherein the frit is metal-free.

8. The frit according to claim 1, comprising at least one of the following features:
wherein the frit is bioinert;
wherein the frit is high pressure tight;
wherein the frit is pressure tight at least up to 1000 bar;
wherein the frit comprises a thickness in a range from 0.1 mm to 10 mm;
wherein the frit comprises a thickness in a range from 0.3 mm to 1 mm;
wherein the frit comprises an outer diameter in a range from 1 mm to 20 mm;
wherein the frit comprises an outer diameter in a range from 3 mm to 10 mm;
wherein the filter unit comprises an outer diameter in a range from 0.5 mm to 10 mm;
wherein the filter unit comprises an outer diameter in a range from 1 mm to 4 mm.

9. The frit according to claim 1, wherein the frit comprises a sealing structure for fluid-tightly connecting the frit to a fitting.

10. The frit according to claim 9, wherein the sealing structure comprises at least one selected from the group consisting of:
a ceramic sealing ring arranged at the holding unit and formed as one piece with the holding unit;
a sealing ring made of a bioinert metal and attached to the holding unit;
a sealing ring made of gold and attached to the holding unit;
a sealing ring attached to the holding unit; and embedded in a ring groove and/or in at least one blind hole of the holding unit; and
a sealing ring made of a plastic attached to the holding unit, and embedded in a ring groove and/or in at least one blind hole of the holding unit.

11. A filter component for connecting to a fluid conduit for filtering a fluid in a sample separation device, the filter component comprising:
the frit according to claim 1; and
a fitting for receiving the frit for fluidically connecting the frit) to the fluid conduit.

12. The filter component according to claim 11, comprising one of the following material pairings:
a material of the frit which is in contact with the fitting at a sealing position is ceramic, and a material of the fitting which is in contact with the frit at the sealing position is a plastic;
a material of the frit which is in contact with the fitting at the sealing position is gold, and a material of the fitting which is in contact with the frit at the seating position is steel.

13. The filter component according to claim 11, wherein the fitting comprises parts that are screwable to each other for fluid-tightly receiving the frit.

14. A sample separation device for separating a fluidic sample that is in a mobile phase into fractions, the sample separation device comprising:
a fluid drive for conveying the mobile phase and/or the fluidic sample;
a sample separation unit downstream of the fluid drive for separating the sample in the mobile phase; and
at least one frit according to claim 1 for filtering at least a part of the mobile phase and/or the fluidic sample and/or for hindering a stationary phase of the sample separation unit to leave the sample separation unit.

15. The sample separation device according to claim 14, comprising at least one of the following features:
wherein at least one of the at least one frit is arranged downstream of the fluid drive:
wherein at least one of the at least one frit is arranged between the fluid drive and the sample separation unit;
wherein at least one of the at least one frit is arranged between a sample introduction unit for inserting the fluidic sample in the mobile phase and the sample separation unit;
wherein at least one of the at least one frit is arranged upstream of the fluid drive:
wherein at least one of the at least one frit is arranged at a solvent container for providing a solvent for the mobile phase;
wherein at least one of the at least one frit is arranged between a solvent container for providing a solvent for the mobile phase and the fluid drive;
wherein at least one of the at least one frit is arranged at an inlet and/or at an outlet of the sample separation unit.

16. The sample separation device according to claim 14, further comprising at least one of the following features:
the sample separation device is configured for analyzing at least one physical, chemical and/or biological parameter of the fluidic sample;
the sample separation device comprises at least one selected from the group consisting of: a detector device; a device for a chemical, biological and/or pharmaceutical analysis; a chromatography device; a liquid chromatography device; a gas chromatography device; and a HPLC-device;
the sample separation device is configured as a microfluidic device;
the sample separation device is configured as a nanofluidic device;
the sample separation unit is configured as a chromatographic separation unit;
the sample separation unit is configured as a chromatography separation column;
the fluid drive is configured for driving the mobile phase with a pressure of at least 100 bar;
the fluid drive is configured for driving the mobile phase with a pressure of at least 500 bar;
the fluid drive is configured for driving the mobile phase with a pressure of at least 1200 bar;
the sample separation device comprises a sample introduction unit for inserting the fluidic sample in the mobile phase;
the sample separation device comprises a detector for detecting the separated fluidic sample;
the sample separation device comprises a sample fractionator for fractionizing the separated fluidic sample.

17. A method for manufacturing a frit for a sample separation device for separating a fluidic sample, the method comprising:
producing a holding unit made of ceramic;
producing a filter unit made of ceramic which is held by the holding unit for filtering a fluid; and
forming the holding unit and the filter unit as one piece.

18. The method according to claim 17, comprising at least one of the following features:
simultaneously forming and connecting the holding unit and the filter unit;
simultaneously forming and connecting the holding unit and the filter unit by sintering;
simultaneously forming and connecting the holding unit and the filter unit under application of a sinter force;
simultaneously forming and connecting the holding unit and the filter unit under heating to a sinter temperature.

19. The method according to claim 17, comprising producing the filter unit by sintering a mixture of sinterable particles and a volatile medium, so that, after sintering, the sinterable particles form the filter unit and the volatile medium evaporates during sintering, leaving pores behind.

20. The method according to claim 17, comprising producing the holding unit by sintering a mixture of sinterable particles.
